(19) United States
(12) Patent Application Publication
(10) Pub. No.: US 2026/0111686 A1
(43) Pub. Date: Apr. 23, 2026

(54) SYSTEMS AND METHODS FOR PAGE SUMMARIZATION

(71) Applicant: ServiceNow, Inc., Santa Clara, CA (US)

(72) Inventors: Midam Kim, Columbus, OH (US); Corbin Lewis, San Diego, CA (US); Alex Michael Ward, Wheaton, IL (US); Yiying Lee, Santa Clara, CA (US); Aileen Hackett, Santa Clara, CA (US); Michael Elgo, San Diego, CA (US); Pratik Vasant Contractor, Danville, CA (US)

(21) Appl. No.: 19/364,862

(22) Filed: Oct. 21, 2025

Related U.S. Application Data
(60) Provisional application No. 63/709,810, filed on Oct. 21, 2024.

(51) Int. Cl. G06F 40/40; G06F 9/451; G06F 40/14; G06F 40/166

(52) U.S. Cl. CPC G06F 40/40; G06F 9/451; G06F 40/14; G06F 40/166

(57) ABSTRACT

A method, includes receiving a request to summarize a content container of a graphical user interface (GUI), wherein the content container includes a plurality of components, obtaining metadata associated with the content container, generating a plurality of value pairs by applying respective transforms to respective portions of the metadata corresponding to each of the plurality of components of the content container, and generating, by using an LLM, a summary of the content container based on the plurality of value pairs and a summarization prompt.

### CROSS-REFERENCE

This application claims priority from and the benefit of U.S. Provisional Ser. No. 63/709,810, entitled “SYSTEMS AND METHODS FOR PAGE SUMMARIZATION,” filed Oct. 21, 2024, which is herein incorporated by reference in its entirety for all purposes.

### TECHNICAL FIELD

The present disclosure relates generally to a page summarization system that generates a summary of a graphical user interface (GUI).

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, as well as IT infrastructure, such as routers, load balancers, firewalls, switches, etc.) and software resources (e.g. productivity software, database applications, large language models (LLMs), generative artificial intelligence (AI) applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

A graphical user interface (GUI) generated via the cloud computing infrastructure may be complex and include information via multi-tiered sub-interfaces with various navigation paths, nested tabs, concealed panels, large tables, and/or complex graphs. It may be difficult for users with limited vision, or users with limited experience using the GUI, to comprehend all of the information being presented by the GUI. Screen readers can summarize information provided on a GUI by providing an audio or textual summary of the GUI. However, such audio or textual summaries of the GUI can be surface level, incomplete, and treat all information presented via the GUI uniformly (e.g., failing to emphasize higher priority aspects of the GUI), leading to a corresponding reduction in utilization of processing or memory resources. Indeed, screen readers may utilize text strings from images of the GUI, which may limit the accuracy and completeness of the information, as the information stored on the GUI may not include the all the information associated with the GUI. Further, users may navigate the screen readers by navigating from one textual element to another until the user locates the desired element, which may consume excessive time and computing-power. Accordingly, improved techniques for summarizing complex GUIs are needed. Even experienced, unimpaired users may appreciate the time-saving benefits of an efficient summary of a complex GUI.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method is provided that includes receiving a request to summarize a content container of a graphical user interface (GUI), wherein the content container includes a plurality of components, obtaining metadata associated with the content container, generating a plurality of value pairs by applying respective transforms to respective portions of the metadata corresponding to each of the plurality of components of the content container, and generating, by using an LLM, a summary of the content container based on the plurality of value pairs and a summarization prompt.

In an embodiment, a system is provided that includes processing circuitry and a memory, accessible by the processing circuitry, and storing instructions that, when executed by the processing circuitry, cause the processing circuitry to perform operations including receiving a request to summarize a content container of a graphical user interface (GUI), wherein the content container includes a plurality of components, obtaining metadata associated with the content container, generating a plurality of value pairs by applying respective transforms to respective portions of the metadata corresponding to each of the plurality of components of the content container, and generating, by using an LLM, a summary of the content container based on the plurality of value pairs and a summarization prompt.

In an embodiment, a non-transitory, computer readable medium is provided that includes instructions that, when executed by processing circuitry, cause the processing circuitry to perform operations including receiving a request to summarize a content container of a graphical user interface (GUI), wherein the content container includes a plurality of components, obtaining metadata associated with the content container, generating a plurality of value pairs by applying respective transforms to respective portions of the metadata corresponding to each of the plurality of components of the content container; and generating, by using an LLM, a summary of the content container based on the plurality of value pairs and a summarization prompt.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance, in accordance with aspects of the present disclosure;

FIG. 5 is a flowchart illustrating a method of operating a system designed for page summarization, in accordance with aspects of the present disclosure;

FIG. 6 is a screenshot of a page configured to receive inputs defining a skill variable summary metadata transform, in accordance with aspects of the present disclosure;

FIG. 7 is a screenshot of a page configured to receive inputs defining a default component prompt associated with the metadata transform of FIG. 6, in accordance with aspects of the present disclosure;

FIG. 8 is a screenshot of a list of component-specific implementations, in accordance with aspects of the present disclosure;

FIG. 9 is a screenshot of a page configured to receive inputs defining a metadata transform of a Canvas Toolbar component, in accordance with aspects of the present disclosure;

FIG. 10 is screenshot of a page configured to receive inputs defining a component prompt for the Canvas Toolbar component, in accordance with aspects of the present disclosure;

FIG. 11 is an example of a Graphical User Interface (GUI) to be summarized, in accordance with aspects of the present disclosure;

FIG. 12 is a screenshot of a console log illustrating a FETCH requested and a FETCH succeeded, in accordance with aspects of the present disclosure;

FIG. 13 is a screenshot of a portion of a JSON data file generated based on extracted data, in accordance with aspects of the present disclosure;

FIG. 14 is a screenshot of a portion of the JSON data file generated based on the extracted data, including prompt IDs, in accordance with aspects of the present disclosure;

FIG. 15 is a screenshot of log data, in accordance with aspects of the present disclosure;

FIG. 16 is a screenshot of a portion of the JSON data file, including hydrated prompts, in accordance with aspects of the present disclosure;

FIG. 17 is a screenshot of a page for receiving inputs defining a summarization prompt for page summarization, in accordance with aspects of the present disclosure;

FIG. 18 is the GUI to be summarized of FIG. 11 with a chatbot implementing page summarization in a side bar, in accordance with aspects of the present disclosure; and

FIG. 19 illustrates the detailed flow process between different components.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

A graphical user interface (GUI) may be complex and include information via multi-tiered sub-interfaces with various navigation paths, nested tabs, concealed panels, large tables, and/or complex graphs, which may complicate GUI, particularly for users with limited vision or users with limited experience using the GUI. Screen readers can summarize information provided on a GUI by providing an audio or textual summary of the GUI. However, such audio or textual summaries of the GUI can be surface level, incomplete, and treat all information presented via the GUI uniformly (e.g., failing to emphasize higher priority aspects of the GUI). Accordingly, improved techniques for summarizing complex GUIs are needed.

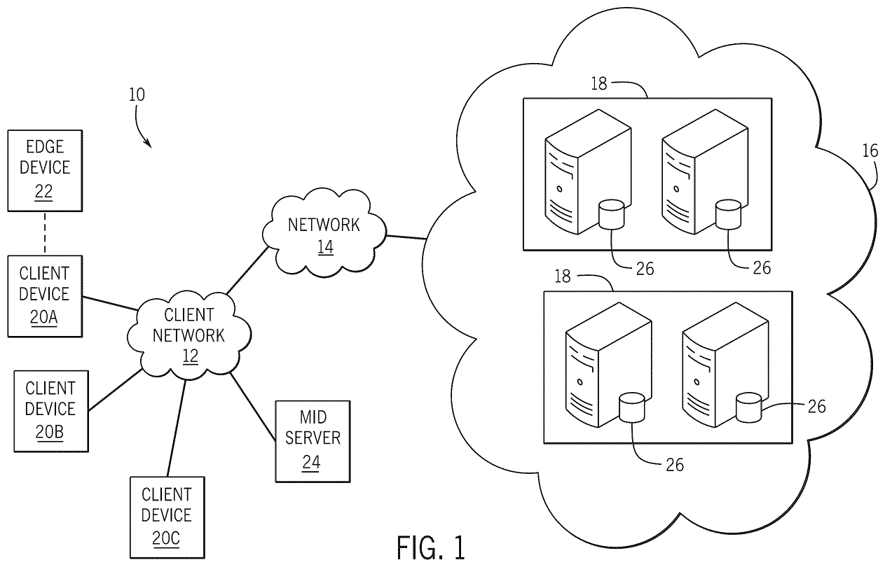

Various embodiments disclosed herein are directed to a page summarization system that generates textual or audio summaries of complex GUIs. The system uses a representational state transfer (REST) application programming interface (API) to communicate between a requesting client device and a server. The system receives a request to summarize a page, retrieves metadata from the document object model (DOM) of the page, as well as the underlying metadata for the GUI (e.g., the data used to generate the various components of the GUI) from a database. The system identifies portions of the retrieved metadata that correspond to each of the components of the GUI and respective transforms associated with each of the components of the GUI. The transforms are client-executed functions tied to DOM traversal, which are configured to convert the metadata to JavaScript object notation (JSON) and insert a component prompt with instructions for interpreting the metadata for the respective component. The system applies the respective transforms to the respective metadata for each of the components of the GUI to generate a JSON file that includes transformed metadata and a component prompt for each component of the GUI. The system transmits the JSON file and a summarization prompt to a large language model (LLM) as an input. The summarization prompt provides instructions to the LLM for summarizing the GUI based on the JSON file. The LLM processes the JSON file based on the summary prompt and outputs a textual summary of the GUI. In some embodiments, the system may transmit the textual summary to the client device for display (e.g., via a chat window). In other embodiments, the system provides the textual summary to a text-to-voice tool to generate an audio summary of the GUI, which the system transmits to the client device to play (e.g., via a speaker). The client device includes an audio output device (e.g., a speaker) that can play audio data provided by the system. With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

Technical effects of the disclosed techniques include receiving a request to summarize a content container including a plurality of components. The system may obtain metadata associated with the content container. Once the system has the metadata, the system may generate a plurality of value pairs by applying respective transforms to respective portions of the metadata corresponding to each of the plurality of components of the content container. The use of metadata in summarization provides a more accurate summary of a page than using an image of a GUI, as the LLM may receive more information of the internal operations of a page for use in summarization, rather than basing the summarization on the appearance of the webpage alone. The use of metadata in summarization provides a more accurate summary of a page than using an image of a GUI, as the LLM may receive more information of the internal operations of a page for use in summarization, rather than basing the summarization on the appearance of the webpage alone. Using an LLM, the system may generate a summary of the content container based on the plurality of value pairs and a summarization prompt. The summary of the content container may include text, an image, or both. The summarization prompt may provide more efficient utilization of resources and computing power by reducing the amount of interaction the user has with the system to convey the same amount of information. The system also reduces system noise by limiting the amount of unnecessary clicking and unhelpful or incomplete summarization, leading to a corresponding reduction in utilization of processing or memory resources.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

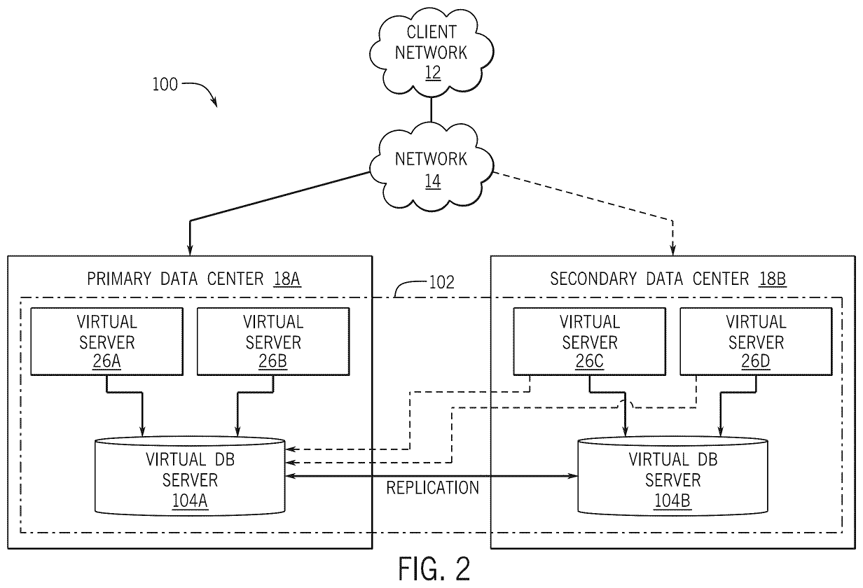

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

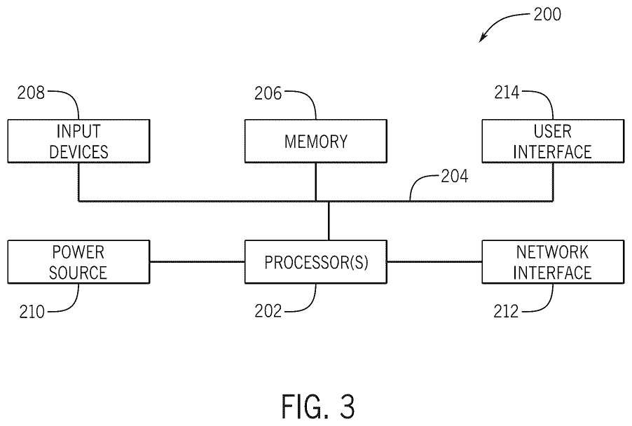

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface may include a display that is configured to display text or images transferred to it from the one or more processors 202. In addition and/or alternative to the display, the user interface 214 may include other devices for interfacing with a user, such as lights (e.g., LEDs), speakers, and the like.

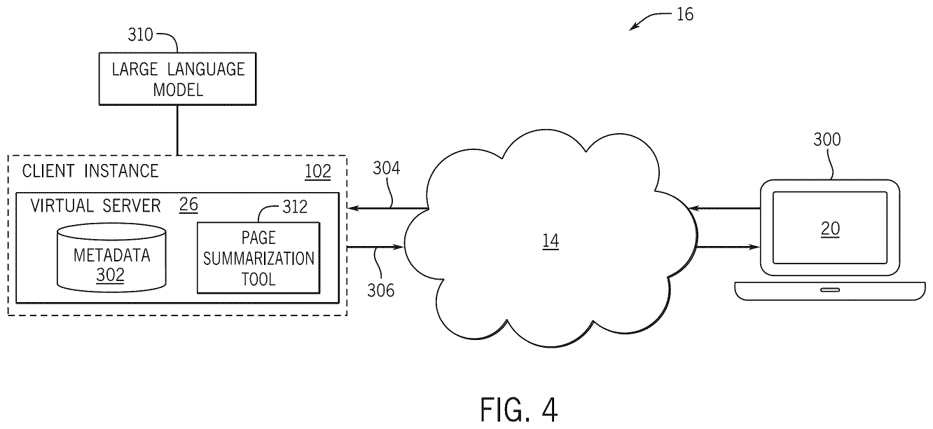

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser 300 or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using an application and/or a web browser 300.

When pages are accessed via the browser 300 or a native application, logic defining various characteristics of the page may be set forth in metadata that are retrieved from the document object model (DOM) of the page when the page is loaded and then executed and/or applied by the client device 20 via the browser 300. Complex pages may be difficult for users to understand, especially users with limited experience, or limited vision. Accordingly, a page summarization tool 312 may be configured to retrieve metadata for a page from a metadata database 302, convert the metadata into a digestible format (e.g., a JSON file), and pass the metadata in a prompt to a large language model (LLM) 310 with a request to summarize the page based on the metadata. The page summarization tool may respond to an input 304 requesting summarization with an output 306 that includes a summary of the page.

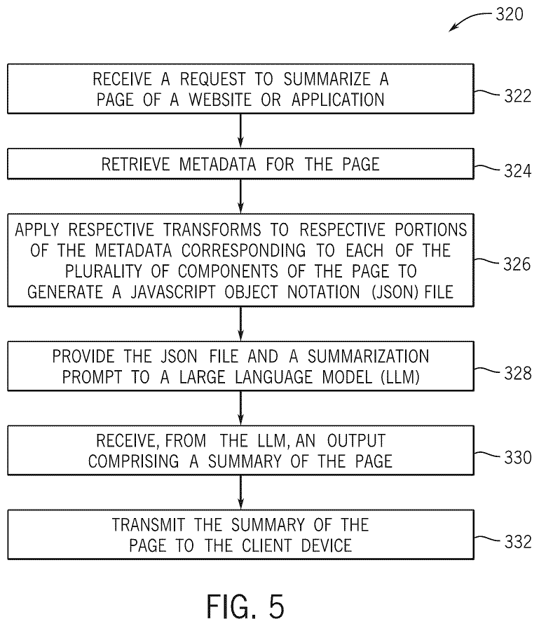

FIG. 5 is a flowchart illustrating the process 320 of running the page summarization script. The system uses a representational state transfer (REST) application programming interface (API) to communicate between a requesting client device and a server. The system receives a request to summarize a page, retrieves metadata from the DOM of the page, as well as the underlying metadata for the GUI (e.g., the data used to generate the various components of the GUI) from a database. The system identifies portions of the retrieved metadata that correspond to each of the components of the GUI and respective transforms associated with each of the components of the GUI. The system may then utilize the metadata to generate a page summary based on the user request.

At block 322, the artificial intelligence system may receive a request from a client device to summarize a content container (e.g., page of a website or an application). The content container may include a plurality of components. These components may be various tabs, drop-down menus, graphs, charts, images, descriptions, bodies of texts, polls, sliding tools, buttons, or other interactive or non-interactive aspects of a GUI or webpage.

At block 324, the system may use the REST API to retrieve metadata associated with the content container. The metadata may be a page title, description, key words, an author's name, language, the creation date, the content type, the character set, and any other information about the page or any links on the page.

At block 326, once the system retrieves metadata for the page, the system applies a respective transform to each respective portion of the metadata corresponding to each of the plurality of components of the page to generate a JSON file. The JSON file may include transformed metadata for each of the plurality of components and a component prompt for each of the plurality of components with instructions for interpreting the transformed metadata for the respective component. Applying respective transforms to respective portions of the metadata corresponding to each of the plurality of components in the content container may generate a plurality of value pairs. The system may wrap the results of the JSON file into a final summary for the large language model (LLM) to process.

At block 328, the system may then provide the JSON file and a summarization prompt to a large language model (LLM). The summarization prompt may include instructions for summarizing the page based on the JSON file. The LLM may generate a summary of the content container based on the plurality of value pairs and the summarization prompt. The summary of the content container may include text, an image, or both.

At block 330, the system may receive an output including the summary of the content container. The summary may be generalized to encompass a high level explanation and walkthrough of the page of the website. However, in other embodiments, the summary may be specialized based on the user request. For example, the summary may describe how to navigate to a different page, how to fill in a form, or the like.

At block 332, the system may transmit the summary of the content container to the client device. The client device includes an audio output device (e.g., a speaker) that can play audio data provided by the system. The transmission may be represented on the client device in a text format, as an audio explanation, or both. For example, in some embodiments, the system may display the summary in an AI chatbot screen on the user's page where the user initially requested the summary. In other embodiments, the system may display the summary as a pop up screen on the page. In still other embodiments, the system may vocalize the summary. The summary may be a vocalized version of the text summary or may be a version of the summary more conducive to vocalization. For example, the vocalized version may be more conversational than a textual version. To generate a vocalized version, the system may utilize a text-to-voice system configured to convert the textual summary to an audio summary.

The system may utilize the metadata associated with one or more aspects of a page, or the page as a whole, to create a summary of the page. The system may transform applicable sections of the metadata to generate a JSON file associated with the page the system is summarizing. An LLM may then summarize the page using the JSON file and a prompt associated with the page summarization request. As such, the system may provide the requesting user with a summary of the page in a text or voice format.

The page summary may assist users with navigating the page, navigating to a new page, or the like. The summarization may provide the user with instructions in the summary, which may explain the page to the user, reducing unwanted, unhelpful, or accidental page selections by the user. Reducing unwanted selections may reduce the computing power utilized by reducing the amount of interaction the user has with the system to convey the same amount of information. Specifically, the system may reduce the amount of clicks, searches, and undesirable page search paths a user may pursue. As such, the system also reduces system noise by limiting the amount of unnecessary clicking and unhelpful or incomplete summarization, leading to a corresponding reduction in utilization of processing or memory resources.

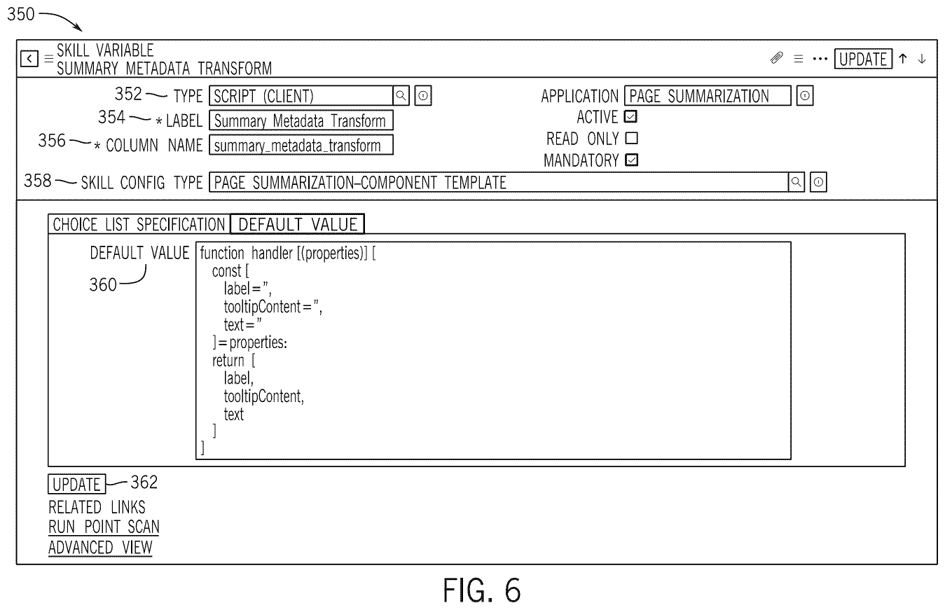

FIG. 6 is a screenshot of a page 350 configured to receive inputs defining a skill variable summary metadata transform. When a user requests a system to complete a task, the request may dictate what transforms are allowed and what transforms are disallowed. Allowed transforms are transforms approved to use metadata necessary to achieve the goal of the transform. In one embodiment, transforms may be allowed based on the user's selected transforms. Specifically, the transforms may be user-executed functions tied to DOM traversal. As such, the user may select what transforms are utilized to traverse the DOM. For example, the user's prompt selections may determine what transforms are allowed. If the user selects the summary prompt, the summary metadata transform may be allowed.

Disallowed transforms are transforms disapproved from using metadata. In one embodiment, disallowed transforms may be transforms associated with prompts the user did not select. The transform is disapproved from using metadata and traversing the DOM because it is not a transform in use. Because transforms are user-executed functions, a transform may be disallowed if the user chose not to execute it. In another embodiment, disallowed transforms may be transforms associated with prompts the user deleted or deactivated. For example, the user may determine a prompt is not applicable to their needs and deactivate the prompt as an option, while leaving the associated transform in the list of transforms. Deleting and deactivating the prompt associated with a transform may prevent the user from activating the associated transform, which may disallow the transform. Allowing and disallowing transforms may be advantageous by limiting the amount of processor resources and space utilized for each action.

In the “Type” box 352, the user may select the type of transform. In one embodiment, the type of transform may be a Client Script.

In the “Label” box 354, the user may input the label that may appear in the JSON file. This may assist the user in knowing what to look for in the JSON file. In one embodiment, the user may insert a descriptive phrase into the box. For example, the user may insert “Summary Metadata Transform”into the box.

In the “Column name” box 356, the user may insert the name of the column in the JSON file. In one embodiment, the user may insert a descriptive phrase into the box. The program may utilize underscores between each word. The program may also not utilize spaces in the title. For example, the user may insert “summary_metadata_transform”into the box.

In the “Skill config type” box 358, the user may insert the type of skill the transform is configured to complete. In one embodiment, the user may insert a descriptive phrase into the box. For example, the user may insert “Page Summarization - Component Template”into the box.

In the “Default Value” box 360, the user may insert the code for the component transform associated with the previous boxes in FIG. 6.

The user may also select or deselect whether the application is active, read only, or mandatory. The transform may be active, read only, mandatory, a combination thereof, or none of the former. If a transform is active, the user may select the transform using the system, and the system may run the transform. In some embodiments, if the transform is mandatory, then it may run every time the user requests any transform to run, in conjunction with the transform the user requested. In other embodiments, the transform may run regardless of if the user requests a transform to run. For example, the transform may run when the user first opens the page.

When the user has completed inputting the transform information, the user may select “Update” button 362 in the lower left-hand corner to save the new transform information.

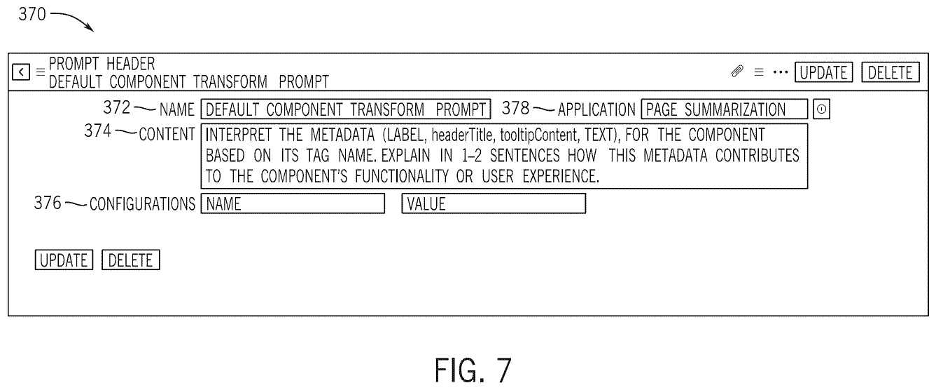

FIG. 7 illustrates a screenshot of a sample component transform prompt 370. When the LLM processes the property information, the Component Transform Prompt may be sent to the LLM alongside the property information. The “Name” box 372 at the top of the screenshot may provide a place for the user to name the component prompt. In one embodiment, the user may insert a descriptive phrase into the box. For example, the user may name the component transform prompt “Default Component Transform Prompt.” This may indicate to the user that the content of the prompt will be automatically implemented unless the user selects a different component transform prompt.

The box below the “Name” box 372 may be a “Content” box 374. The “Content” box may allow the user to enter the component transform prompt itself. This prompt may be used to instruct the system on what the user wants the system to do. In one embodiment, the user may instruct the system to interpret the metadata of a component and explain the impact of the metadata on the component's functionality. For example, the user may ask the system to explain the impact of metadata on a pie chart or graph on the page. The system may then use that prompt to identify the necessary information to accomplish the prompt.

The boxes below the “Content” box 374 may be one or more “Configurations”boxes 376. In one embodiment there may be one configurations box.

For example, the transform prompt may only allow for one configuration, which may only utilize one configuration. In other embodiments, there may be more than one configurations box 376. There may be multiple configurations for one or more prompts based on the user's needs or desires. For example, the user may input a name configuration and a value configuration. This may be advantageous by providing the user with multiple configuration options and adapting to meet the user's preferences.

The “Application” box 378 in the upper right-hand corner labeled lists the application associated with the component transform prompt. In one embodiment, the user may be able to select the related application from a drop-down menu of existing applications. For example, the user may select the “Page Summarization” application from a list of existing applications to associate the prompt with an application. This may be advantageous by limiting the number of typos and other errors that may be associated with a user typing in the prompt name.

In another embodiment, the user may not be able to select the associated application on the transform prompt page. Instead, the associated application may automatically populate in the “Application” box 378 based on the user entering the prompt page through a page directed to the associated application. This may be advantageous by limiting mistakes regarding which prompt is associated with which application.

In another embodiment, the user may type the name of the associated application into the “Application” box 378. For example, the user may type the name “Page Summarization” into the “Application” box 378. This may be advantageous by providing the user the option to create the prompt of an associated application before creating the associated application.

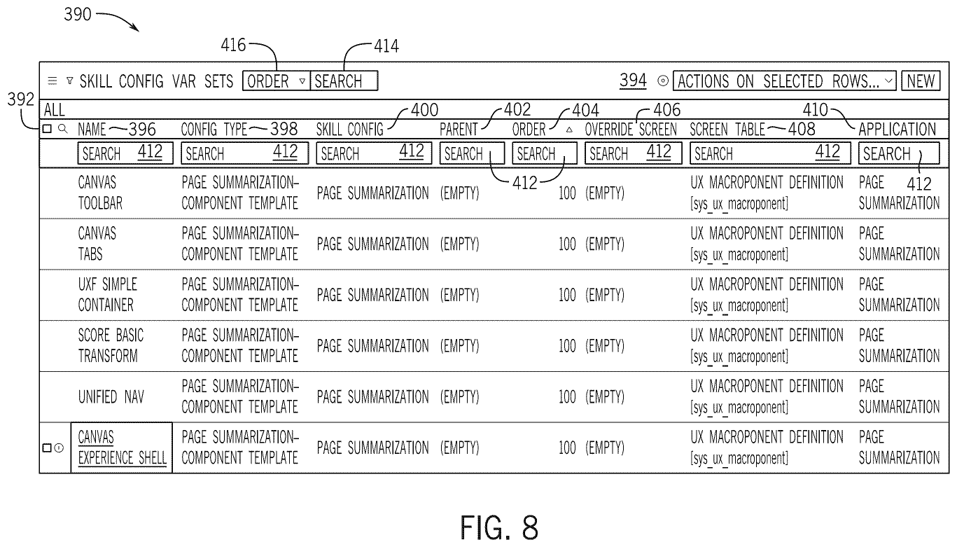

FIG. 8 is a screenshot 390 of a list of component specific implementations. The implementations are designed to analyze the relevant aspects of the page to be summarized. The far-left column 392 allows the user to select and deselect what implementations are to be summarized. The user may select any of the listed component specific implementations and view or edit the prompts associated with each one.

In one embodiment, the user may deselect component implementations that are not to be summarized. For example, if the user does not want to have the canvas tabs analyzed, the user may deselect that implementation. By selecting the implementation, the page summarization application may run faster or more efficiently, because it does not have as much to analyze and summarize.

In the upper right-hand corner of the webpage, there may be a drop-down menu 394 to provide a user with a list of possible actions the user may perform on the selected rows. For example, the user may delete selected rows. This may be advantageous by providing the user with a more efficient method of altering or deleting multiple component-specific implementations.

The “Name” column 396 may list the name of each component specific implementation. The names in this column may be selectable, which may open the prompt or transform for the component specific implementation associated with the name.

The “Config Type” column 398 may list the type of configuration of the component-specific implementation. The configuration type in this column may be selectable, which may open the prompt or transform for the component specific implementation associated with that row. This may be advantageous by allowing the user to easily access and view or edit the component prompt or transform.

The “Skill Config” column 400 may list the skill configuration for the associated prompt or transform. For example, if the prompt of transform is configured to assist with the page summarization application, the row may say “Page Summarization.” The skill configuration in this column may be selectable, which may open the prompt or transform for the component specific implementation associated with that row. This may be advantageous by allowing the user to easily access and view or edit the component prompt or transform.

The “Parent” column 402 may list the parent associated with each prompt or transform. Specifically, if the component-specific implementation is related to a component nested inside another component, the parent column may be populated with the relevant parent component. For example, if the Canvas Tabs component had Tabs within each tab, the component-specific implementation for the tabs within the Canvas Tabs might list “Canvas Tabs”in the column of the tabs within the Canvas Tabs row. This may be advantageous by providing the user with a method for determining what components are nested within other components.

The “Order” column 404 may provide the user a way to organize the component-specific implementations. The “Order” column 404 may have a numeric value. The numeric value may be automatically assigned by the system, or the numeric value may be assigned by the user. In some embodiments, the order may correspond to another aspect of the component-specific implementations, such as the skill configuration, configuration type, parent, application, or a combination thereof. For example, the order may be based on a combination of the skill configuration and the skill type. This combination may be advantageous by providing the user with a way to sort through the component specific implementations by the configuration details.

In other embodiments, the order value may be an arbitrary number assigned by the user. For example, the user may decide all canvas related components have the order number 30, while any non-canvas related components have the order number 10. This may be advantageous if the user has an internal organization system the user wants to implement.

The “Override Screen” column 406 may provide the user with an indication of whether there is an override attached to the component-specific implementation, which would allow the user to stop an application from implementing a prompt or transform for a specific component.

The “Screen Table” column 408 may identify a table that stores data for the page, component, GUI, etc. The system may utilize the data and metadata in the identified table for summarization. In some embodiments, the system may summarize the data in the table. In other embodiments, the system may utilize the data to generate a summary for the page. For example, if the table stores data intended for direct use by the user, the system may summarize the table in its page summary. However, if the table stores data used by other components of the page, the system may utilize the data to assist in summarizing the other components.

The “Application” column 410 may display the name of the application associated with its respective component-specific implementation. The application name in this column may be selectable, which may open the prompt or transform for the component specific implementation associated with that row. This may be advantageous by allowing the user to easily access and view or edit the component prompt or transform.

Each column may have a search box 412. The user may use the search box 412 to look for a specific phrase or word in each category to assist the user with locating a specific component-specific implementation. This may be advantageous by saving time for the user if there are many component-specific implementations to look through.

Similarly, there may be a search bar 414 at the top of the webpage. This search bar 414 functions in the same or a substantially similar manner to the search box 412 in each column. However, this search bar 414 is accompanied by a drop-down menu 416 which may provide the user a way to select what category (e.g., name, configuration type, skill type, order, parent, override screen, screen table, or application) the user is searching in.

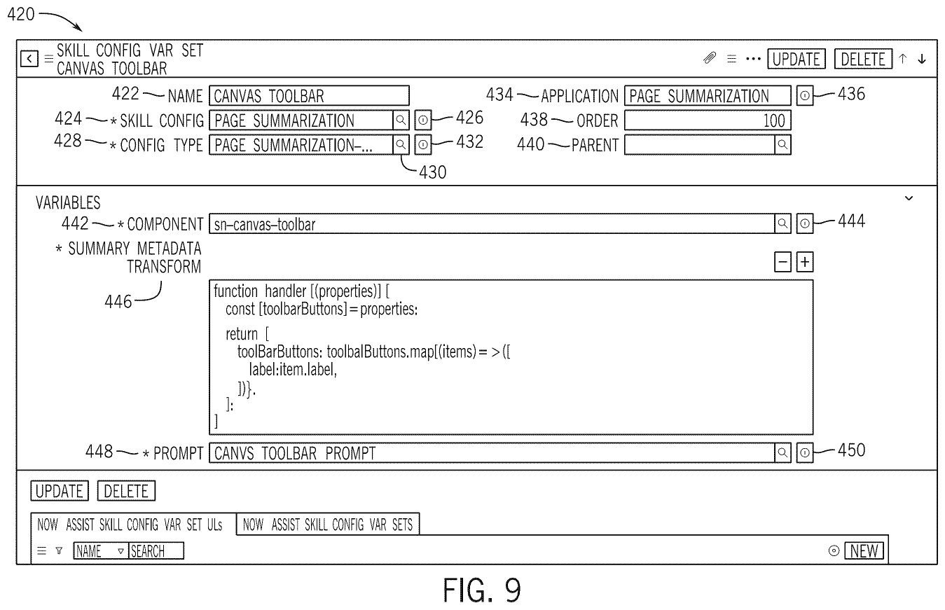

FIG. 9 is a screenshot of a screen 420 configured to receive inputs defining a metadata transform for a component of the page to be summarized. When the system receives a request to summarize a page, the system feeds the identified portions of the underlying metadata corresponding to each component of the GUI to its corresponding component transform. The transform for each component converts the metadata into a JSON file.

The “Name” box 422 at the top of the screen labeled may provide a place for the user to name the component prompt. In one embodiment, the user may insert a descriptive phrase into the box. For example, the user may name the component transform prompt “Canvas Toolbar.” This may indicate to the user that the content of the prompt will be applies to the canvas toolbar of a page to be summarized.

Below the “Name” box 422 is a “Skill Config” box 424. The “Skill Config” box 424 may provide a place where the user can list the skill configuration associated with the metadata transform of the relevant component. In an embodiment, the user may use this box to search for an existing skill configuration using the search button next to the box. For example, the user may type in part of a specific skill configuration and select the accompanying magnifying glass to search for the specific skill configuration. This may be advantageous by saving the user time or providing the user the option to search for the specific skill configuration when the user may not know the exact name of the skill configuration.

In another embodiment, the user may type in the name of the skill configuration without utilizing the search capability of the box. This may be advantageous for saving time searching when the user knows the name of the specific skill configuration.

Next to the search bar for the skill configuration box 424 may be an information button 426. If the user is unsure what the skill configuration is for, or what the selected skill configuration is associated with, the user may select the information button 426 to learn more information.

Below the “Skill Config” box 424 is a “Config Type” box 428. The “Config Type” box 428 may provide a place where the user can list the configuration type associated with the metadata transform of the relevant component. In an embodiment, the user may use the “Config Type” box 428 to search for an existing configuration type using the search button 430 next to the “Config Type” box 428. For example, the user may type in part of the configuration type and select the accompanying magnifying glass to search for the configuration type. This may be advantageous by saving the user time or providing the user the option to search for the desired configuration type when the user may not know the exact name of the configuration type.

In another embodiment, the user may type in the name of the configuration type without utilizing the search capability of the “Config Type” box 428. This may be advantageous for saving time searching when the user knows the name of the desired configuration type.

Next to the search bar for the configuration type box 428 may be an information button 432. If the user is unsure what the configuration type is for, or what the selected configuration type is associated with, the user may select the button to learn more information.

The “Application” box 434 in the upper right-hand corner may list the application associated with the component transform prompt. In one embodiment, the user may be able to select the related application from a drop-down menu of existing applications. For example, the user may select the “Page Summarization” application from a list of existing applications to associate the prompt with an application. This may be advantageous by limiting the number of typos and other errors that may be associated with a user typing in the prompt name.

In another embodiment, the user may not be able to select the associated application on the transform prompt page. Instead, the associated application may automatically populate in the “Application” box 434 based on the user entering the prompt page through a page directed to the associated application. This may be advantageous by limiting mistakes in which prompt is associated with which application.

In another embodiment, the user may type the name of the associated application into the “Application” box 434. For example, the user may type the name “Page Summarization” into the “Application” box 434. This may be advantageous by providing the user the option to create the prompt of an associated application before creating the associated application itself.

Next to the application box 434 may be an information button 436. If the user is unsure what the application is for, or what the selected application is associated with, the user may select the information button 436 to learn more information.

The “Order” box 438 may provide the user a way to organize the component-specific implementations. The “Order” box 438 may have a numeric value. The numeric value may be automatically assigned by the system, or the numeric value may be assigned by the user. In some embodiments, the order may correspond to another aspect of the component-specific implementations, such as the skill configuration, configuration type, parent, application, or a combination thereof. For example, the order may be based on a combination of the skill configuration and the skill type. This combination may be advantageous by providing the user with a way to sort through the component specific implementations by the configuration details.

In other embodiments, the order value may be an arbitrary number assigned by the user. For example, the user may decide all canvas related components have the order number 30, while any non-canvas related components have the order number 10. This may be advantageous if the user has an internal organization system the user wants to implement.

Below the “Order” box 438 may be a “Parent” box 440. The “Parent” box 440 may provide a place where the user can list the parent associated with the metadata transform of the relevant component. In an embodiment, the user may use this box to search for an existing parent using the search button next to the box. For example, the user may type in part of the desired parent and select the accompanying magnifying glass to search for the desired parent. This may be advantageous by saving the user time or providing the user the option to search for the desired parent when the user may not know the exact name of the parent.

In another embodiment, the user may type in the name of the parent without utilizing the search capability of the “parent” box 440. This may be advantageous for saving time searching when the user knows the name of the desired parent.

The “component” box 442 may list the variable associated with that component. The user may determine the name of the variable associated with the component and type it into the “component” box 442. This component variable may appear in the code when the user runs the application. In an embodiment, the user may use the “component” box 442 to search for an existing component variable using the search button next to the “component” box 442. For example, the user may type in part of the desired component variable and select the accompanying magnifying glass to search for the desired component variable. This may be advantageous by saving the user time or providing the user the option to search for the desired component variable when the user may not know the exact name of the component variable.

In another embodiment, the user may type in the name of the component variable without utilizing the search capability of the “component” box 442. This may be advantageous for saving time searching when the user knows the name of the desired component variable.

Next to the search bar for the component variable box may be an information button 444. If the user is unsure what the component variable is for, or what the selected component variable is associated with, the user may select the information button 444 to learn more information.

The “Summary Metadata Transform” box 446 may provide the user a place to type in the metadata transform associated with the relevant component. The metadata transform may be used when the user runs the application to massage the metadata into a form understandable by the LLM.

The “Prompt” box 448 may list the prompt associated with that component. The user may determine the prompt associated with the component and type it into the “prompt” box 448. This component prompt may be distributed with the metadata transform when the user runs the application. In an embodiment, the user may use this box to search for an existing prompt using the search button next to the “prompt” box 448. For example, the user may type in part of the prompt name and select the accompanying magnifying glass to search for the prompt. This may be advantageous by saving the user time or providing the user the option to search for the prompt when the user may not know the exact name of the prompt.

In another embodiment, the user may type in the name of the prompt without utilizing the search capability of the “prompt” box 448. This may be advantageous for saving time searching when the user knows the name of the prompt.

Next to the search bar for the prompt box 448 may be an information button 450. If the user is unsure what the prompt is for, or what the prompt is associated with, the user may select the information button 450 to learn more information.

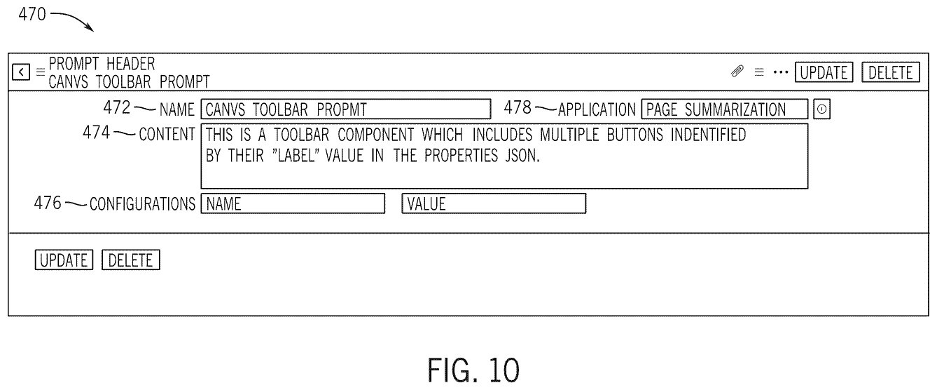

FIG. 10 is a screenshot 470 of a filled in prompt. The “Name” box 472 at the top of the screen labeled may provide a place for the user to name the component prompt. In one embodiment, the user may insert a descriptive phrase into the “Name” box 472. For example, the user may name the component transform prompt “Canvas Toolbar Prompt.” This may indicate to the user that the content of the prompt will address the canvas toolbar when running the associated application.

The box below the “Name” box 472 may be a “Content” box 474. The “Content” box 474 may allow the user to describe the component for the system to reference when the application is run. In one embodiment, the user may explain the canvas toolbar, what it includes, and how it relates to the properties JSON for the component properties.

The boxes below the “Content” box 474 may be one or more “Configurations” box 476. In one embodiment there may be one configurations box 476. For example, the transform prompt may only allow for one configuration, which may only utilize one configuration. In other embodiments, there may be more than one configurations box 476. There may be multiple configurations for one or more prompts based on the user's needs or desires. For example, the user may input a name configuration and a value configuration. This may be advantageous by providing the user with multiple configuration options and adapting to meet the user's preferences.

The “application” box 478 in the upper right-hand corner lists the application associated with the component transform prompt. In one embodiment, the user may be able to select the related application from a drop-down menu of existing applications. For example, the user may select the “Page Summarization” application from a list of existing applications to associate the prompt with an application. This may be advantageous by limiting the number of typos and other errors that may be associated with a user typing in the prompt name.

In another embodiment, the user may not be able to select the associated application on the transform prompt page. Instead, the associated application may automatically populate in the “Application” box 478 based on the user entering the prompt page through a page directed to the associated application. This may be advantageous by limiting mistakes in which prompt is associated with which application.

In another embodiment, the user may type the name of the associated application into the “Application” box 478. For example, the user may type the name “Page Summarization” into the “Application” box 478. This may be advantageous by providing the user the option to create the prompt of an associated application before creating the associated application.

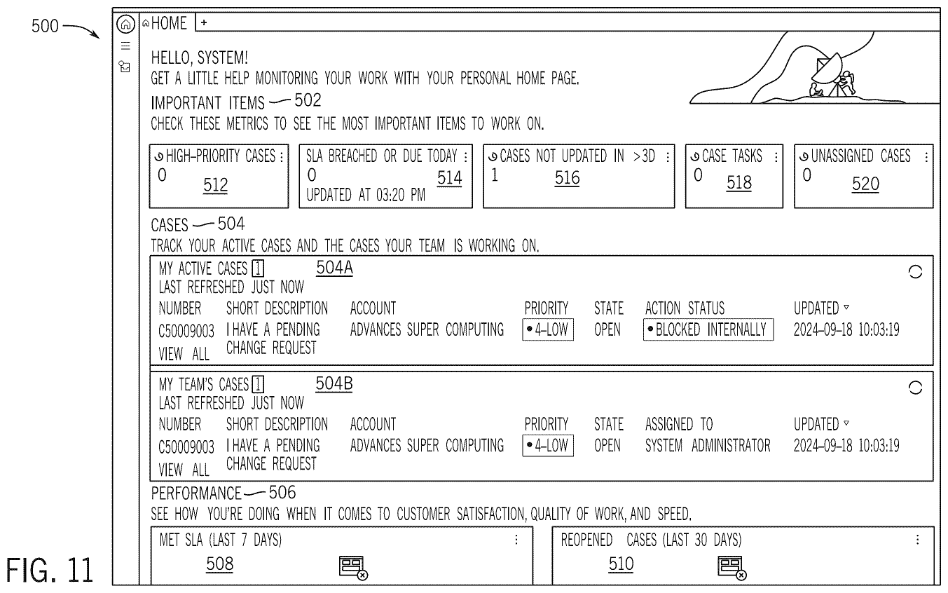

FIG. 11 is a screenshot 500 of a GUI which the page summarization application may summarize. In some embodiments, the application may summarize all of the components of the GUI. The components may include different aspects the user may want to know about. In the illustrated embodiment, the components include important items 502, cases 504, and performance 506. However, the components may include subcomponents. For example, in the illustrated embodiment, the important items 502 may include high-priority cases 512, SLA breached or due today 514, cases not updated in more than 3 days 516, case tasks 518, and unassigned cases 520. Further, in the illustrated embodiment, the cases 504 includes active cases 504A and the team's cases 504B, and the performance component 506 includes the Met SLA 508 and the reopened cases 510. For example, the application may explain that the GUI is a personal home page intended to help users monitor their work. It may explain that there is one case not updated in more than 3 days, but that there are no high-priority cases, no SLA breaches or due today as of 3:20 pm, and no case tasks or unassigned tasks. The application may also explain the details of the user's case, stating that it is a low priority case relating to a pending change request which was last updated on Sep. 18, 2024 at 10:03:19. The application may go on to summarize that the same case is assigned to the user's team as well, and that the case was specifically assigned to the system administrator. This may be advantageous to provide users with a high-level overview of the page. This may be especially advantageous when the user first sees the page that day.

In another embodiment, the page summarization may focus on summarizing only specific aspects of the page. For example, the user may be concerned with only the user's active cases. The user may ask the application to only summarize the active cases on the page. The application may then describe the user's active cases, listing the account the case is with, the priority of the case, whether the case is open, what the action status is, what the case number is, and when the case was last updated. This may be advantageous by providing users only with needed information and may be beneficial when the user has already seen the page for the past few hours and only needs a reminder or an update on active cases. In embodiments in which the user requests the page summarization tool summarizes multiple sections of the page, the page summarization tool may generate a comprehensive summary of each section of the page, separating the summarization process into sections to minimize mixing summaries associated with different elements.

When a system receives a request to summarize a page, the system retrieves metadata from the DOM of the page, as well as the underlying metadata for the GUI from a database. The DOM of the page may have a seismic framework under the Shadow DOM. The seismic framework may express the source data's states, properties, and behavior. Further, the seismic framework may extract all data to summarize the data. For example, the seismic framework may extract the type of chart, the title of the chart, and all the data on a chart without utilizing anything rendered on the GUI. As such, the seismic framework may simplify the component framework. The seismic framework may prepare the browser with complete information page summarization tool utilizes for its processing. In some embodiments, the system will retrieve all the metadata related to a GUI. This may occur when the user requests a full-page summarization of the entire GUI.

In other embodiments, the system may retrieve only metadata related to the aspects of the GUI the user requested the system to summarize. For example, if the user requested only a summarization of the active cases represented on the GUI, the system would retrieve the metadata related to the user's active cases, but not retrieve metadata not related to the user's active cases. This may be advantageous by reducing the processing load on the computer, making the computer more efficient.

In another embodiment, the system may retrieve all metadata related to the GUI, but disregard metadata not related to aspects the GUI for which the user requested summarization. For example, if the user requested only a summarization of the active cases represented on the GUI, the system would retrieve the metadata for the entire GUI, but disregard any metadata not related to the user's active cases when completing the requested summarization. This may be advantageous by providing a way to limit forgotten metadata because the system will retrieve all metadata

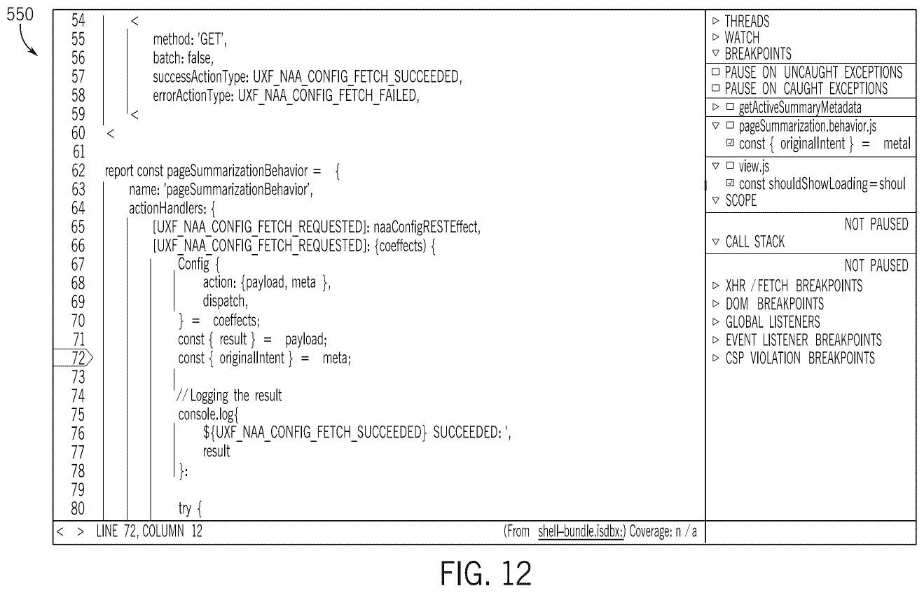

FIG. 12 is a screenshot 550 of a console log illustrating a FETCH requested and a FETCH succeeded. When a user requests the system run an application, the console log may illustrate the request and the progress made towards that request. For example, the console log may show that the user requested that the system run the page summarization application. The console log may make this representation by showing at least one aspect of the request in the console log (e.g. application name, component names, etc.). The system may also show what information the system has retrieved for the request. For example, the console log may show the components it used, the metadata it retrieved, or any other piece of information the system utilized in running the application.

In one embodiment, the console log may automatically pop up for the user when the user requests the system run an application. This may be advantageous to provide users with an understanding of how the system operates. In another embodiment, the console log may remain hidden unless the user requests to view the console log. This may be advantageous to user who do not want to view the console log, by hiding the console log unless the user needs to view the console log and specifically asks.

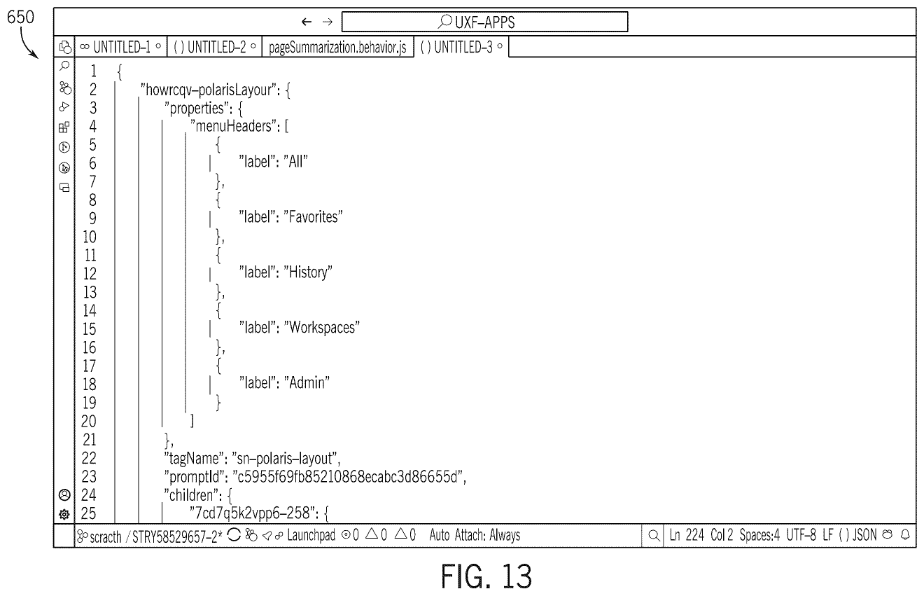

FIG. 13 is a screenshot 650 of a portion of a JSON file for the extracted metadata. The application may transform metadata extracted from the GUI using the component-specific implementation transforms. These transforms convert the metadata into a JSON file. The system may then utilize the JSON file to distill the information included on a page into a summary.

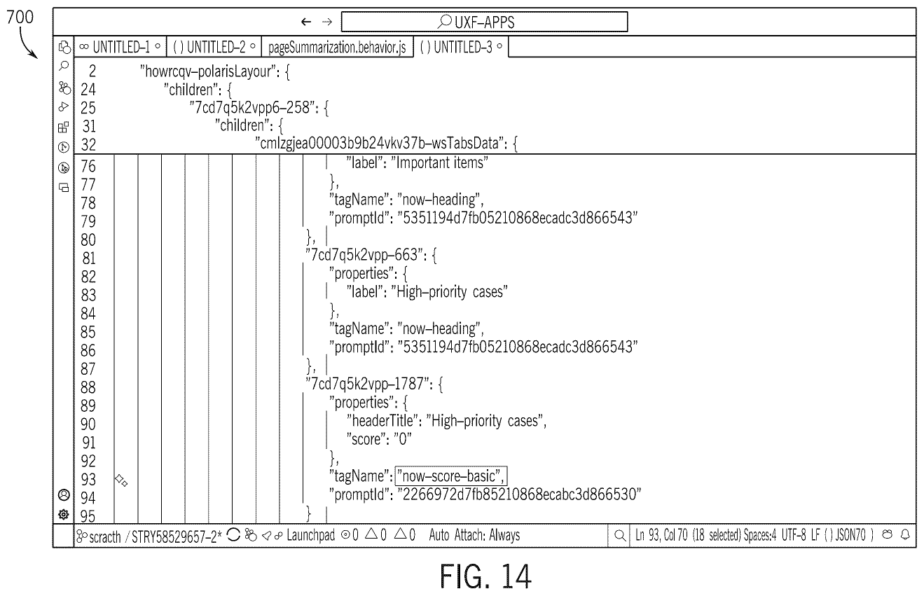

FIG. 14 is a screenshot 700 of a portion of the JSON file for extracted data with prompt IDs. The JSON file includes prompt IDs associated with each component prompt. The system may select the relevant component prompts based on the user's selected application and the level of summarization the user requested. For example, if the user requests a full-page summarization, the JSON for the extracted data will include all the prompt IDS for every component on the GUI. However, if the user only requested a partial page summarization, the JSON file will only include prompt IDs for the components of the GUI present in the section or sections of the GUI the user requested summarization of.

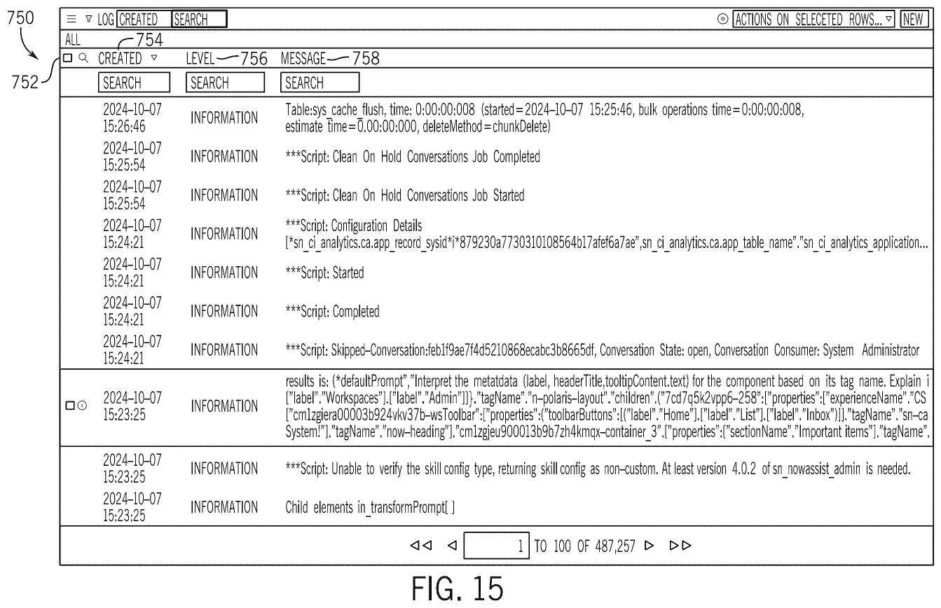

FIG. 15 is a screenshot 750 of log data. The log data shows a simplified view of the request the application sends to the LLM. The log data may allow the user to troubleshoot any issues with the application or the LLM. The log may include a selection column 752 to select or deselect different messages generated by the log. The log may also feature a time column 754 for time stamps associated with the log data. The time stamps for each feature may include a date of log data creation, a time of log data creation, or both.

Further, the log may also feature a level column 756 to advise the user of the level of data. Specifically, the level column may identify whether the data in the log is an error (e.g., if the system failed to accomplish a step for the application) or if the data is information (e.g., if the system accomplished a step for the application). The level column 756 may identify what steps of the application could not be completed and why. This may be advantageous by allowing the user to decide whether the section of the application the system did not run was important. For example, the system may advise the user that the application was unable to retrieve allowed languages for the current model. The user may then decide if the user believes that is an important step they need the application to run, cand can work towards addressing the issue.

The log may also include a message column 758 addressing the message associated with each piece of data in the log. The message column 758 may advise the user what occurred during that step.

Each column, some columns, or no columns may have a search function. The search function may allow the user to search for different aspects of the log data. For example, the user may search the level column to look for errors. This may be advantageous when there are many pieces of data in the log by allowing the user to more quickly find what the user is looking for, rather than the user individually searching through hundreds or thousands of pieces of data in the log.

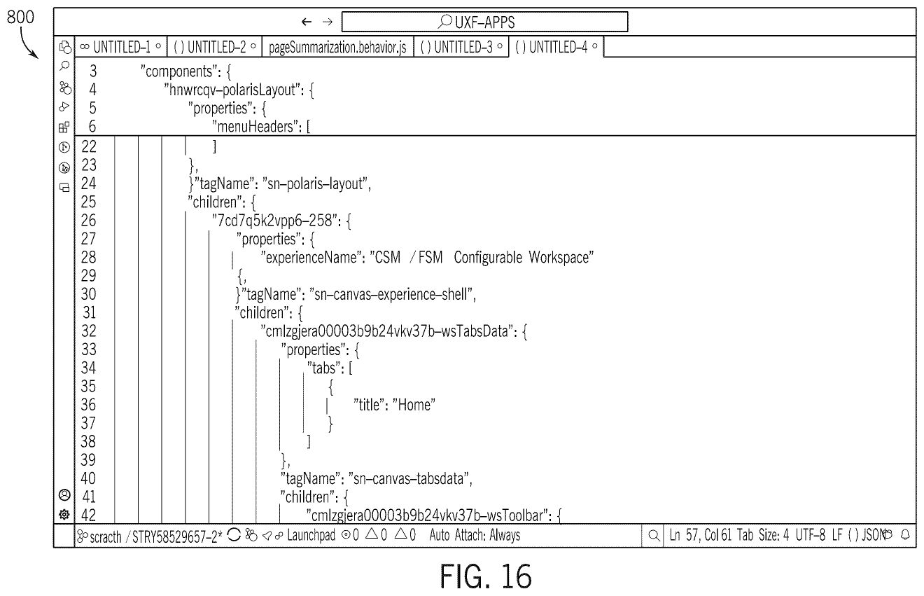

FIG. 16 is a screenshot 800 of a portion of the JSON file with hydrated prompts. The JSON data illustrated here replaced the prompt IDs represented in FIG. 15 with the information stored in the relevant prompts for each component of the GUI. At this stage in the application, the JSON file includes transformed metadata, as well as the component prompt for each component of the GUI. Each component prompt features instructions for interpreting the metadata for each component. The system may submit this JSON file to the LLM as an input.

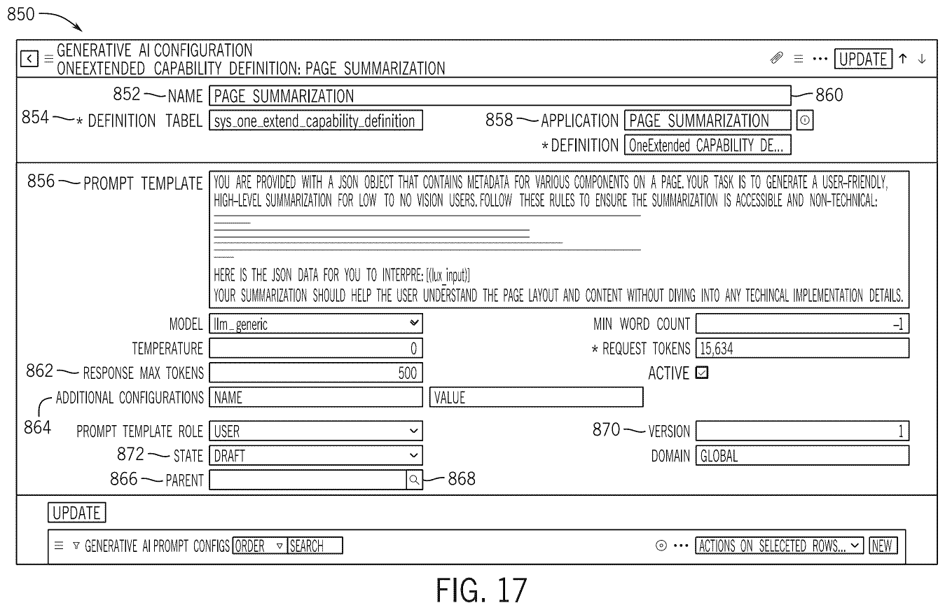

FIG. 17 is a screenshot 850 of the GUI with the “main” (e.g., summarization) prompt for page summarization. This main prompt is sent alongside the JSON file shown in FIG. 17 to the LLM. The main prompt instructs the LLM on summarizing the GUI based on the data stored in the JSON file. The main prompt may include the requested summary. Specifically, the main prompt may include the amount of information the user requested. In some embodiments, the main prompt may be a request for a high level summary of the entire page. In other embodiments, the main prompt may be a request for an explanation for navigating to a specific part of the page, or for navigating through a specific task associated with the page (e.g., filling out a form). In other embodiments, the main prompt may be for a high level summary of the entire page, with permission for the LLM to not summarize certain aspects based on the understanding the user has of the page. For example, if the user understands one aspect of the page, but needs an explanation of the rest of the page, the main prompt may request the LLM to summarize the page but to avoid summarizing the already understood aspect.

The “Name” box 852 at the top of the screen may provide a place for the user to name the component prompt. In one embodiment, the user may insert a descriptive phrase into the “name” box 852. For example, the user may name the prompt “Page Summarization. ” This may indicate to the user that the content of the prompt will summarize the GUI page when running the associated application. There may also be a definition table box 854 for a definition table, and a box for a definition.

There may be a “Prompt Template” box 856 which may provide the user a place to enter the main prompt itself. This prompt may be used to instruct the system what to do. In one embodiment, the user may instruct the system to interpret the metadata of the entire GUI and explain the impact of the metadata on the functionality of each component's metadata. For example, the user may ask the system to explain the impact of metadata on a pie chart or graph on the page. The system may then use that prompt to identify the necessary information to accomplish the prompt.

Further, the main prompt may utilize a minimum word count. The minimum word count may be the minimum number of words in the system's textual response to the user's requests. In some embodiments, the user may desire a minimum word count of 0 words or fewer. This may be advantageous when the user wants the system to have flexibility in its response. In other embodiments, it may be advantageous to have a minimum word count greater than 0 when the user desires a response from the system regardless of whether the system has anything on the GUI to summarize based on the user's selected summarization. For example, if the user selects a summarization of graphs on the page, but the page does not include graphs, the system may respond with an indication that the page does not include graphs.

The “Application” box 858 in the upper right-hand corner lists the application associated with the component transform prompt. In one embodiment, the user may be able to select the related application from a drop-down menu of existing applications. For example, the user may select the “Page Summarization” application from a list of existing applications to associate the prompt with an application. This may be advantageous by limiting the number of typos and other errors that may be associated with a user typing in the prompt name.

In another embodiment, the user may not be able to select the associated application on the transform prompt page. Instead, the associated application may automatically populate in the “Application” box 858 based on the user entering the prompt page through a page directed to the associated application. This may be advantageous by limiting mistakes in which prompt is associated with which application.

In another embodiment, the user may type the name of the associated application into the “Application” box 858. For example, the user may type the name “Page Summarization” into the “Application” box 858. This may be advantageous by providing the user the option to create the prompt of an associated application before creating the associated application.

There may be an information button 860 next to the box labeled “Application. ” If the user is unsure what the application is for, or what the selected application is associated with, the user may select the button to learn more information.

There may also be additional customizations the user may make (e.g. model, temperature, response max tokens, prompt template role, request tokens, domain, version, etc.). The user may also select or deselect whether the main prompt is active. If the active box is selected, the user may use the system to run the prompt.

The boxes below the “Response Max Tokens” box 862 may be one or more “Configurations” box 864. In one embodiment there may be one configurations box. For example, the transform prompt may only allow for one configuration, which may only utilize one configuration. In other embodiments, there may be more than one configurations box 864. There may be multiple configurations for one or more prompts based on the user's needs or desires. For example, the user may input a name configuration and a value configuration. This may be advantageous by providing the user with multiple configuration options and adapting to meet the user's preferences.

The prompt may also have a “Parent” box 866. The “parent” box 866 may provide a place where the user can list the parent associated with the main prompt. In an embodiment, the user may use the “parent” box 866 to search for an existing parent using the search button 868 next to the “parent” box 866. For example, the user may type in part of the desired parent and select the accompanying magnifying glass to search for the desired parent. This may be advantageous by saving the user time or providing the user the option to search for the desired parent when the user may not know the exact name of the parent.

In another embodiment, the user may type in the name of the parent without utilizing the search capability of the “parent” box 866. This may be advantageous for saving time searching when the user knows the name of the desired parent.

The prompt may also feature a version box 870 where the user may list what version of the main prompt the prompt is. This may be advantageous to inform the user how many variations on the prompt exist and what prompt is the most up-to-date.

Further, the prompt may feature a state box 872 where the user may list whether the prompt is a draft or final version. This may be advantageous by providing the user with a way to keep track of which versions of the main prompt are still in progress and which versions are complete.

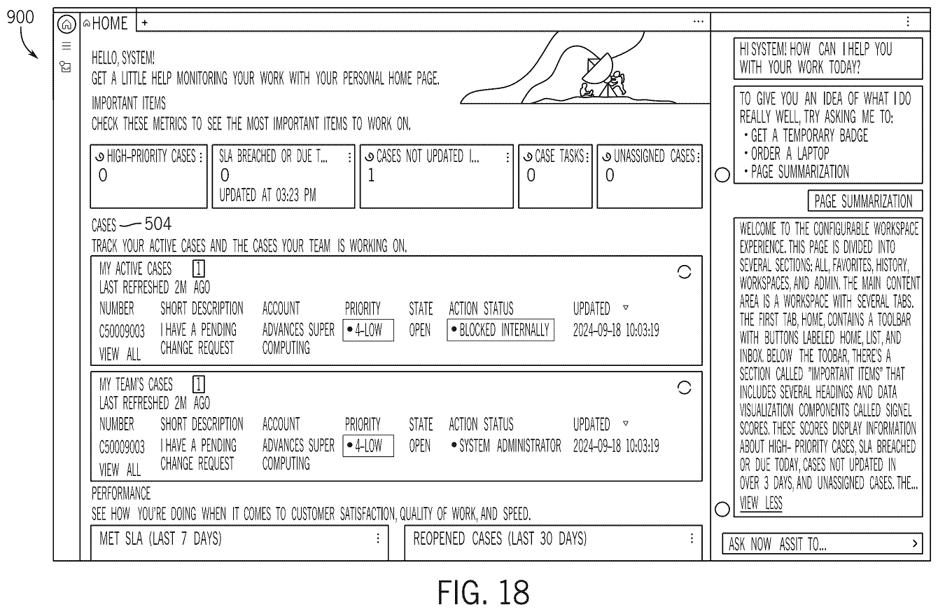

FIG. 18 is an example GUI 900 with a chatbot implementing page summarization in the side bar. A user may open the Artificial Intelligence (AI) chatbot screen 902 from the user's GUI. The AI chatbot screen 902 may be a side bar, a pop-up window, or a full screen view. The AI chatbot may ask the user what the user needs assistance with. In one embodiment, the AI chatbot may provide options to the user relating to possible applications the chatbot may run. For example, the chatbot may list applications including get a temporary badge, order a laptop, full page summarization, partial page summarization, or another user-created application based on what applications exist in the chatbot system. Once the chatbot provides the user with application options, the user may select an application from the options. After the user has selected a chosen application, the system may run the application and provide the user with the requested result based on the application the user selected.

In another embodiment, the AI chatbot may nest application options within larger options. For example, the chatbot may provide the user with a list of applications including a page summarization option. When the user selects the page summarization option, the chatbot may then provide the user with more detailed options relating to page summarization, such as providing an option for full summarization, or different variations on partial summarization (e.g., active case summary, important items summary, my team's cases summary, etc.). This may be advantageous when the chatbot has many different applications it may run because it limits the amount of options on screen at one time, which may simplify the experience for the user.

In another embodiment, the user may request the system run an application without the AI chatbot providing a list of application options. Specifically, the user may type into the chat box that it wants the system to run a specific application. For example, the user may type into the chat box “page summarization” because the user is aware that page summarization is an available application. The AI may then ask the user a question to clarify the user's request. For example, if the user requested page summarization, and the system offered several variations of the page summarization application, the system may ask the user to select one of the page summarization options. As another example, if the user misspelled the name of an application, the chatbot may inform the user the application is not recognized or, if the user's typo was minor, the chatbot may select the application closest to the misspelled application name and ask the user to verify its name selection. This may be advantageous by limiting the number of options the chatbot has to display at one time, which may benefit processing speeds of the system.

When the user selects an application, the LLM creates and processes the JSON file based on the summary prompt in FIG. 18 and outputs a textual summary of the GUI based on the page summarization application the user selected. In some embodiments, the system may transmit the textual summary to the client device for display (e.g., via a chat window). In other embodiments, the system provides the textual summary to a text-to-voice tool to generate an audio summary of the GUI, which the system transmits to the client device to play (e.g., via a speaker). In still other embodiments, the system may transmit the textual summary to the client device for display and to play, so the client device will both display the textual output and read the output aloud to the user.

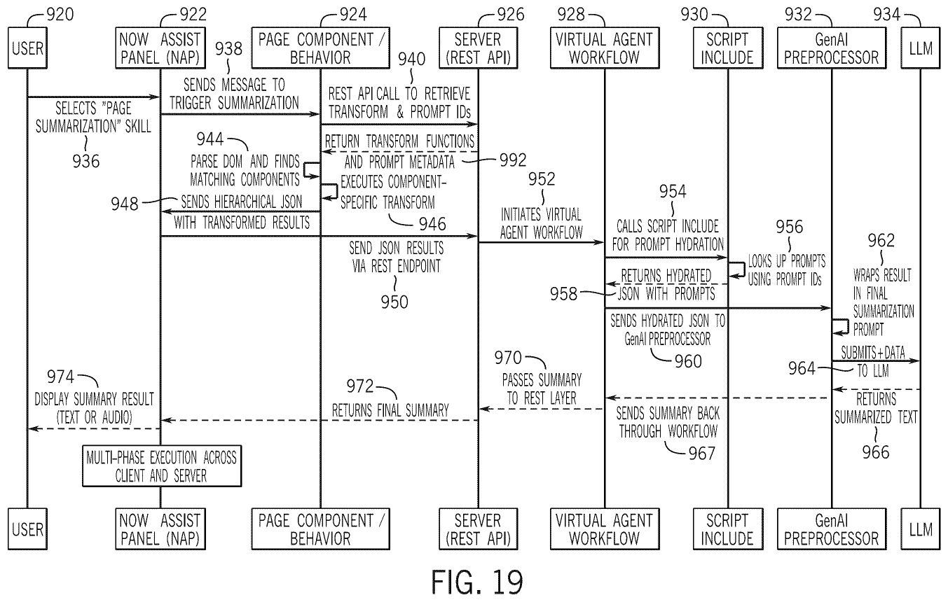

FIG. 19 illustrates the detailed flow process between different components. The process starts with the user 920 selecting the “Page Summarization” skill at process step 936. The system may then transmit the selection to the Assist Panel 922. The Assist Panel 922 may then send a message to trigger summarization to a component or behavior of a page 924 at process step 938. From there, the REST API 926 may retrieve the transforms and prompt IDs at process step 940 and return the transform functions and prompt metadata at process step 942. The page component 924 may then parse the DOM for the page component 924 and find matching components at process step 944. The page component 924 may also execute the component-specific transforms at process step 946.

The page component 924 may send a hierarchical JSON with transformed results to the Assist Panel 922 at process step 948. The Assist Panel 922 may then send the JSON results to the REST API 926 via the REST endpoint at process step 950. The REST API 926 may initiate the virtual agent workflow 928 at process step 952. The virtual agent workflow 928 may call script include 930 for prompt hydration at process step 954. Script include 930 may search for prompts using prompt IDs at process step 956. The script include 930 may then return hydrated JSONs with prompts to the virtual agent workflow 928 at process step 958. The virtual agent workflow 928 may then send the hydrated JSON prompts to a generative AI processor 932 at process step 960. The generative AI processor 932 may wrap the results of the hydrated JSON in the final summarization prompt at process step 962. The generative AI processor 932 may then submit the final summarization prompt and the data to the LLM 934 at process step 964. Once the LLM 934 processes the final summarization prompt and the data, the LLM 934 may return summarized text to the generative AI processor 932 at process step 966. The generative AI processor 932 may send the summary back through the virtual agent workflow 928 at process step 968. Once the summary has passed through the virtual agent workflow 928, the virtual agent workflow 928 may pass the summary to the REST API 926 at block 970. The REST API 926 may then return a final summary to the Assist panel 922 at process step 972. The Assist Panel 922 may then display the summary results to the user 920 at process step 974. As discussed previously, the summary results display may be audio, visual, or both.

The presently disclosed techniques are directed to a page summarization system that generates textual or audio summaries of complex GUIs. The system uses a representational state transfer (REST) application programming interface (API) to communicate between a requesting client device and a server. The system receives a request to summarize a page, retrieves metadata from the DOM of the page, as well as the underlying metadata for the GUI (e.g., the data used to generate the various components of the GUI) from a database. The system identifies portions of the retrieved metadata that correspond to each of the components of the GUI and respective transforms associated with each of the components of the GUI. The transforms convert the metadata to JavaScript object notation (JSON) and insert a component prompt with instructions for interpreting the metadata for the respective component. The system applies the respective transforms to the respective metadata for each of the components of the GUI to generate a JSON file that includes transformed metadata and a component prompt for each component of the GUI. The system transmits the JSON file and a summarization prompt to a large language model (LLM) as an input. The summarization prompt provides instructions to the LLM for summarizing the GUI based on the JSON file. The LLM processes the JSON file based on the summary prompt and outputs a textual summary of the GUI. In some embodiments, the system may transmit the textual summary to the client device for display (e.g., via a chat window). In other embodiments, the system provides the textual summary to a text-to-voice tool to generate an audio summary of the GUI, which the system transmits to the client device to play (e.g., via a speaker).

Technical effects of the disclosed techniques include receiving a request to summarize a content container including a plurality of components. The system may obtain metadata associated with the content container. Once the system has the metadata, the system may generate a plurality of value pairs by applying respective transforms to respective portions of the metadata corresponding to each of the plurality of components of the content container. The use of metadata in summarization provides a more accurate summary of a page than using an image of a GUI, as the LLM may receive more information of the internal operations of a page for use in summarization, rather than basing the summarization on the appearance of the webpage alone. Using an LLM, the system may generate a summary of the content container based on the plurality of value pairs and a summarization prompt. The summarization prompt may provide more efficient utilization of resources and computing power by reducing the amount of interaction the user has with the system to convey the same amount of information. The system also reduces system noise by limiting the amount of unnecessary clicking and unhelpful or incomplete summarization, leading to a corresponding reduction in utilization of processing or memory resources.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a request to summarize a content container of a graphical user interface (GUI), wherein the content container includes a plurality of components;
obtaining metadata associated with the content container, wherein a plurality of portions of the metadata respectively corresponds to the plurality of components of the content container;
generating a plurality of value pairs based on the plurality of portions of the metadata and the plurality of components of the content container; and
generating, via a language model, a summary of the content container based on the plurality of value pairs.

2. The method of claim 1, wherein generating the plurality of value pairs includes applying respective transforms to the plurality of portions of the metadata corresponding to each of the plurality of components of the content container.

3. The method of claim 1, wherein generating the plurality of value pairs includes converting the metadata to a JavaScript Object Notation (JSON) file.

4. The method of claim 1, further comprising providing a page summarization prompt to the language model, wherein generating the summary of the content container is further based on the page summarization prompt.

5. The method of claim 1, further comprising, transmitting, to a client device, the summary of the content container.

6. The method of claim 5, wherein transmitting the summary of the content container includes instructing the client device to update the GUI to include the summary of the content container.

7. The method of claim 1, further comprising:
generating audio data indicative of the summary of the content container; and
transmitting the audio data to a client device.

8. The method of claim 1, wherein the content container comprises a webpage or a component of the webpage.

9. The method of claim 1, wherein obtaining the metadata is from a document object model (DOM) of the content container.

10. The method of claim 1, wherein the summary of the content container includes a combination of text or an image.

11. A system, comprising:
processing circuitry; and
a memory, accessible by the processing circuitry, and storing instructions that, when executed by the processing circuitry, cause the processing circuitry to perform operations comprising:
receiving a request to summarize a content container of a graphical user interface (GUI), wherein the content container includes a plurality of components;
obtaining metadata associated with the content container, wherein a plurality of portions of the metadata respectively corresponds to the plurality of components of the content container;
generating a plurality of value pairs based on the plurality of portions of the metadata and the plurality of components of the content container; and
generating, via a language model, a summary of the content container based on the plurality of value pairs.

12. The system of claim 11, wherein generating the plurality of value pairs includes converting the metadata to a JavaScript Object Notation (JSON) file.

13. The system of claim 11, further comprising, transmitting, to a client device, the summary of the content container.

14. The system of claim 11, further comprising:
generating audio data indicative of the summary of the content container, and
transmitting the audio data to a client device.

15. The system of claim 14, wherein transmitting the summary of the content container includes instructing the client device to update the GUI to include the summary of the content container.

16. The system of claim 11, wherein the content container comprises a webpage or a component of the webpage.

17. The system of claim 11, wherein obtaining the metadata is from a document object model (DOM) of the content container.

18. A non-transitory, computer readable medium comprising instructions that, when executed by processing circuitry, cause the processing circuitry to perform operations comprising:
receiving a request to summarize a content container of a graphical user interface (GUI), wherein the content container includes a plurality of components;
obtaining metadata associated with the content container, wherein a plurality of portions of the metadata respectively corresponds to the plurality of components of the content container;
generating a plurality of value pairs based on the plurality of portions of the metadata and the plurality of components of the content container; and
generating, via a language model, a summary of the content container based on the plurality of value pairs.

19. The medium of claim 18, wherein generating the plurality of value pairs includes converting the metadata to a JavaScript Object Notation (JSON) file.

20. The medium of claim 18, further comprising, transmitting, to a client device, the summary of the content container.
